(19) United States
(12) Patent Application Publication
(10) Pub. No.: US 2011/0244084 A1
(43) Pub. Date: Oct. 6, 2011

(54) PRODUCT MOUNTING SHEET

(75) Inventors: Jaswinder Dhadda, Maharashtra (IN); Sameer Dattatray Mehendale, Maharastra (IN)

(73) Assignee: CADBURY UK LIMITED, Bournville, Birmingham, West Midlands (GB)

(21) Appl. No.: 13/127,581

(22) PCT Filed: Nov. 20, 2009
(86) PCT No.: PCT/GB2009/002710

§ 371 Date: Jun. 16, 2011

(30) Foreign Application Priority Data
Nov. 25, 2008 (GB) 0821509.7

(51) Int. Cl. B65D 85/60; B05D 5/10; B32B 38/14; G09F 19/00; G09F 5/00; A23G 3/56; B65B 3/02

(52) U.S. Cl. 426/106; 427/207.1; 156/277; 40/299.01; 426/132; 426/420; 53/452

(57) ABSTRACT

A product display sheet (1) comprises a display area (3) having a plurality of adhesive areas (7a-7h). Each adhesive area comprises one or more adhesive locations. Each adhesive area is further associated with one or more product identifiers.

The present invention relates to a product display sheet. Such display sheets may be used, for example, to arrange confectionery items in predetermined positions within a package, such as those known as ‘selection boxes’.

A ‘selection box’ consists of an outer package enclosing a number of confectionery products, and is intended to be suitable for presentation as a gift, such as for example at holidays or festivals and other festive occasions. As such, it is desirable for the confectionery products to be arranged in an attractive manner within the outer package. In the absence of specific features to ensure such an arrangement, movement of the confectionery products during transport can reduce the attractiveness of the product arrangement, and hence the perceived value of the selection box.

It is therefore known in the art for such arrangement to be achieved by means of a moulded plastic tray having a number of cavities to receive the confectionery products. Each moulded cavity is appropriately shaped to receive a predetermined type of confectionery product. This has the advantage of ensuring that the products are placed in the correct positions during production, and remain in those positions during transport and display of the selection boxes. Additionally, any missing products are quickly identified, allowing the missing items to be replaced before final packaging.

However, the reliance on moulded plastic trays suffers from a number of disadvantages. In particular, the trays are expensive to design and produce. Any change in the items to be included in the selection box (or even in the arrangement of the existing items) will require the production of a new tray (and hence new moulds), so that temporary replacement of one item with another, for example, is rendered unfeasible.

According to a first aspect of the invention, there is provided a product display sheet comprising a display area having a plurality of adhesive areas, each adhesive area comprising one or more adhesive locations, wherein each adhesive area is further associated with one or more product identifiers.

It will be understood that each adhesive area is distinct from all other adhesive areas. As used herein, a ‘product identifier’ is a means of identifying a product, or a product range from which a product may be selected, intended for attachment to the adhesive area.

In one embodiment, the product identifier comprises a graphical depiction of a product or product range.

In one embodiment, the product identifier comprises text naming and/or describing the product or product range.

In one embodiment, the product identifier comprises a machine-readable description of the product or product range, such as for example a barcode.

In one embodiment, each adhesive area comprises a printed layer and an adhesive layer; wherein the product identifier comprises at least part of the printed layer and the one or more adhesive locations comprise at least part of the adhesive layer. In a further embodiment, at least part of the adhesive layer overlies at least part of the printed layer.

In one embodiment, the product display sheet further comprises one or more release sheets covering substantially all of the adhesive areas. Suitable release sheets include any material which will temporarily adhere to the adhesive areas, but which may be removed without substantially disrupting the integrity of the adhesive areas, such as a silicone-coated film or paper, such as for example a paper of weight 30 to 120 gsm.

In one embodiment, the surface area of each adhesive area is smaller than the surface occupied by the product(s) indicated in the corresponding product identifier(s).

In one embodiment, the display area is substantially planar.

According to a second aspect of the invention, there is provided a product display sheet having a substantially planar display area; and a plurality of groups of confectionery products releasably mounted on the display area by means of adhesive, each group of confectionery products comprising one or more confectionery products; wherein the display area between the groups of confectionery products is substantially free from adhesive.

It will be understood that each group of confectionery products is distinct from all other groups of confectionery products. It will be further understood that, in the context of the invention, ‘releasably mounted thereon’ means that confectionery products may be removed from the product display sheet without substantial damage to the confectionery product.

According to a third aspect of the invention, there is provided a product package comprising a product display sheet, one or more confectionery products releasably mounted on the display sheet by means of adhesive, and a covering material; wherein the one or more products are enclosed between the product display sheet and the covering material.

In one embodiment, the product display sheet is in accordance with the first or second aspects of the invention.

In one embodiment, the covering material comprises a transparent portion which enables viewing of at least one confectionery product within the package.

In one embodiment, the covering material completely encloses the product display sheet and confectionery products mounted thereon. In a further embodiment, the covering material comprises a box enclosing the product display sheet and products mounted thereon. In an alternative further embodiment, the covering material comprises a flexible wrapping. Suitable flexible wrappings are known to the man skilled in the art, and include a cellophane wrapper, a laser-perforated re-closable laminated bag and a paper bag.

In an alternative embodiment, the covering material does not enclose the product display sheet but interacts with the product display sheet in order to enclose the products. Such interaction may be in the form of a physical engagement, attachment with adhesive, or any other form. In a further embodiment, the product display sheet further comprises one or more side walls, and the covering material engages with the one or more side walls in order to enclose the products. In a still further embodiment, the product display sheet comprises a base and four side walls, and the covering material comprises a lid which fits over the side walls to enclose the products.

In one embodiment, the product display sheet comprises a planar display area, and a plurality of products are releasably mounted on the planar display area.

According to a fourth aspect of the invention, there is provided a method for making a product display sheet according to the first aspect of the invention, comprising providing a display sheet having a display area, printing at least first and second regions of the display area with indications of products intended to be attached thereto, and separately coating at least part of each of the first and second regions with a layer of adhesive.

The printing of the base sheet and coating with adhesive may be carried out using any suitable printing process, such as for example screen printing (including automatic, semi-automatic and manual processes) offset (including lithographic offset) or gravure processes. Registration of the product indications and the adhesive layer may be achieved by means of any suitable registration method, such as T-bar, pin-hole or manual alignment.

In one embodiment, the method further comprises applying one or more release sheets over the layer of adhesive in the first and second regions of the display area.

According to a fifth aspect of the invention, there is provided a method for making a product display sheet according to the second aspect of the invention, comprising providing a display sheet having a display area; selectively coating at least first and second regions of the display area with a layer of temporary adhesive; and applying at least one confectionery product to the temporary adhesive in each of the first and second regions so as to substantially cover the temporary adhesive.

According to a sixth aspect of the invention, there is provided a method for making a product package according to the third aspect of the invention, comprising coating at least part of a display sheet with a layer of temporary adhesive; applying one or more products to the temporary adhesive; and applying a covering material to enclose the products between the display sheet and the covering material.

In one embodiment, the covering material is a flexible wrapper, and applying the covering material to enclose the products between the display sheet and the covering material comprises surrounding the display sheet and products with the covering material, and sealing the edges of the covering material so as to enclose the display sheet and products. Sealing the edges of the covering material may be achieved by any suitable means, such as gluing, stitching, stapling, or thermal bonding. In a further embodiment, the covering material comprises a polymer, and sealing the edges of the covering material comprises thermally bonding adjacent edges of the covering material.

In one embodiment, the covering material is a box, and applying the covering material to enclose the products between the display sheet and the covering material comprises placing the display sheet with products attached thereto inside the box.

The box may be formed as a single item, with an open side through which the loaded display sheet is introduced, before the open side of the box is closed. Such a closure may be effected with one or more tabs which are folded and inserted into the main body of the box, or which are joined to one another or to the main body of the box by means of adhesive (such as adhesive tape, hot melt glue, etc.) or any other suitable means.

Alternatively, the closure may comprise a flap which is held in place by an outer wrapping of film or other suitable material.

Alternatively, the box may be formed as a minimum of two separate pieces, such as a base and a lid. In such cases, the loaded product sheet may be placed in or on one of the pieces (such as the base), and the remaining pieces (such as a lid) connected to the first piece to complete the enclosure.

In one embodiment, the covering material is a lid, with at least one of the display sheet and the lid being adapted to engage with the other of the display sheet and the lid.

The following comments apply to all aspects of the invention.

It will be understood that ‘confectionery products’ may refer to wrapped or unwrapped confectionery items, including but not limited to chocolate (and similar materials, such as couverture); fruit, cereal or nut compositions; chewing gum; bubble gum; hard-boiled candy; chewy candy; jelly candy; caramel; toffee; marshmallow; nougat; biscuit; wafer; or any combination thereof. In particular, it may refer to those products generally known as ‘chocolate bars’ and which comprise chocolate or similar material (frequently in the form of a coating), together with other optional ingredients.

The invention will now be described with reference to the accompanying drawings, in which:

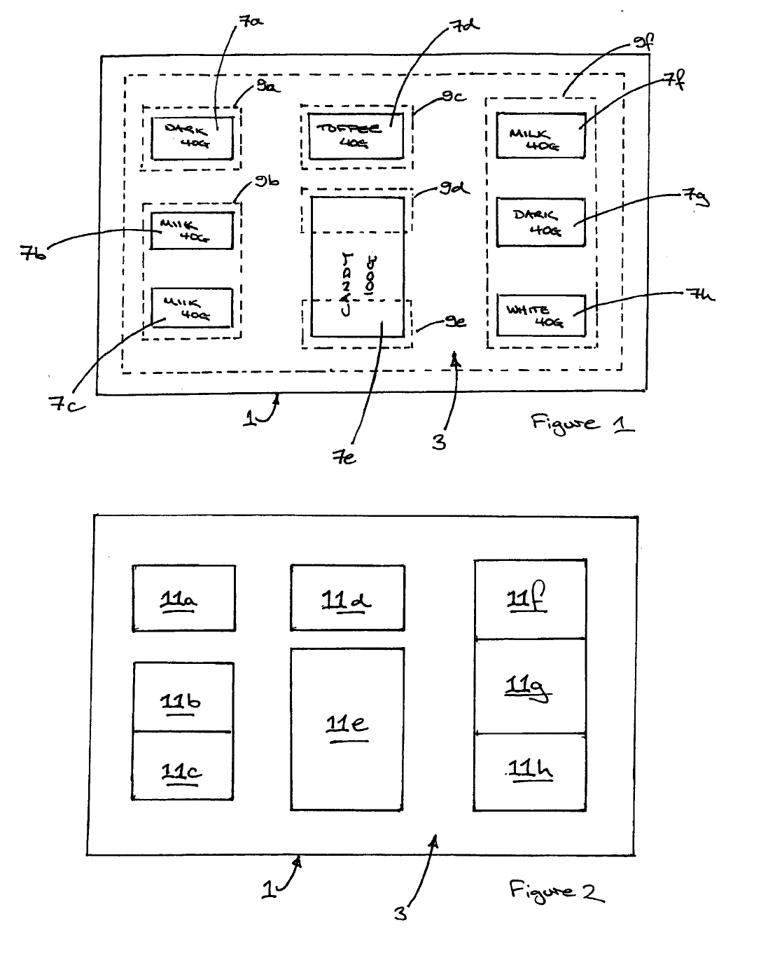

FIG. 1 shows a plan view of a product display sheet according to one embodiment of the first aspect of the invention;

FIG. 2 shows a plan view of the product display sheet of FIG. 1 loaded with confectionery products according to one embodiment of the second aspect of the invention;

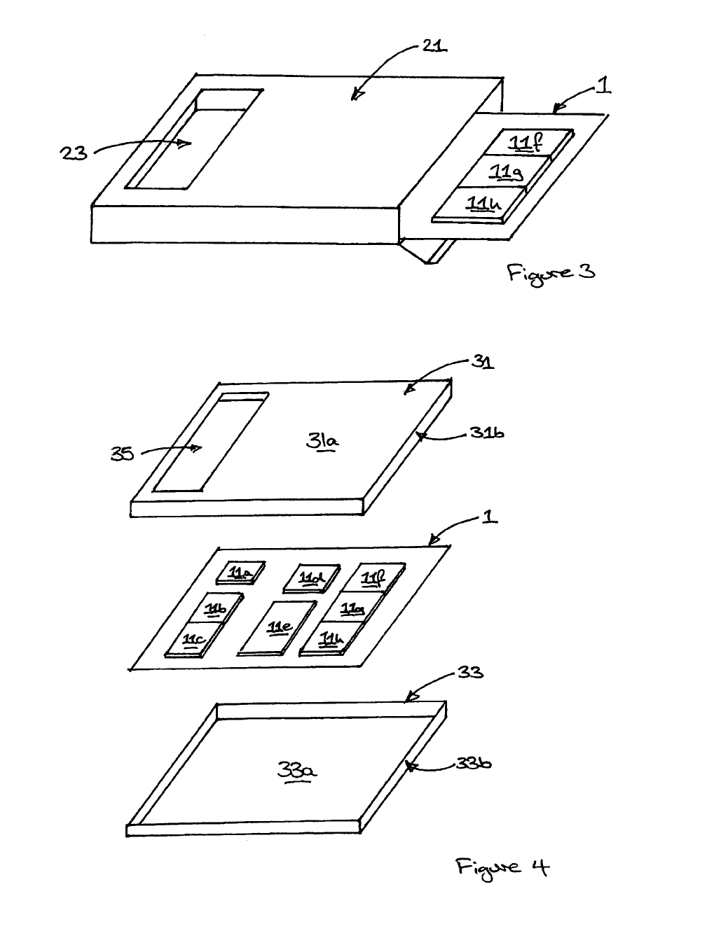

FIG. 3 shows a perspective view of a product package according to one embodiment of the third aspect of the invention;

FIG. 4 shows an exploded perspective view of a product package according to a second embodiment of the third aspect of the invention;

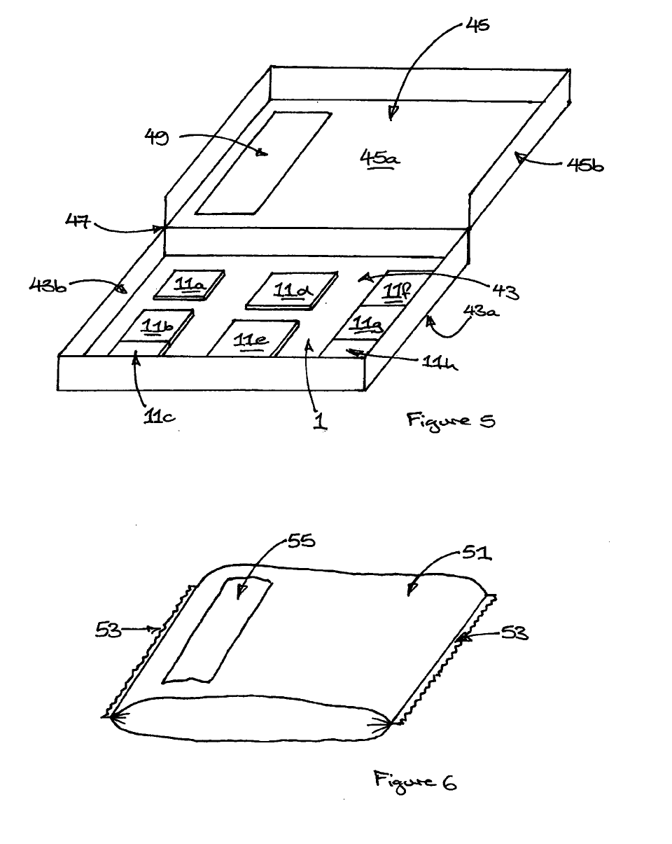

FIG. 5 shows a perspective view of a product package according to a third embodiment of the third aspect of the invention; and

FIG. 6 shows a perspective view of a product package according to a fourth embodiment of the third aspect of the invention.

Referring to FIG. 1, product display sheet 1 consists of a planar sheet of 260 gsm duplex card. One surface of the card forms a display area 3. On this display area are marked several product locations 7a to 7h, each product location 7a to 7h identifying the product to be placed thereon.

Also printed on the display area 3 are several adhesive locations 9a to 9f. The adhesive locations 9a to 9f and the product locations 7a to 7h are grouped together as shown in Table 1.

TABLE 1
Groups of adhesive areas

| Group | Adhesive locations | Product locations |
|---|---|---|
| 1 | 9a | 7a |
| 2 | 9b | 7b & 7c |
| 3 | 9c | 7d |
| 4 | 9d & 9e | 7e |
| 5 | 9f | 7f, 7g & 7h |

Within each group, the adhesive locations 9a to 9f extend beyond the bounds of the product locations 7a to 7h.

Referring to FIG. 2, confectionery products 11a to 11h are placed over the corresponding product locations 7a to 7h. Each confectionery product is larger in size than the corresponding product location, to that the product location is not visible with the confectionery product in place. The confectionery products are held in place by the adhesive areas 9a to 9f.

Referring to FIG. 3, the display sheet 1 with attached confectionery products 11a to 11h is placed inside an outer cardboard box 21. A transparent panel 23 in the upper surface of the box 21 permit a consumer to view at least some of the confectionery products 11a to 11f without opening the box 21.

Referring to FIG. 4, the display sheet 1 with attached confectionery products 11a to 11h is alternatively placed inside a two-part box consisting of a lid portion 31 and a base portion 33. Each of the lid portion 31 and the base portion consists of a rectangular planar sheet 31a, 33a with sidewalls 31b, 33b extending continuously around the perimeter thereof. The size of the lid portion 31 is such that the lid portion sidewalls 31b fit snugly around the outside of the base portion sidewalls 33b.

The loaded display sheet 1 is placed on the planar sheet 33a of the base portion, between the base portion side walls 33b, and the lid portion 31 is placed over the base portion 33 in order to enclose the confectionery products 11a to 11h. A transparent portion 35 in the planar sheet 31a of the lid portion permit the consumer to view at least some of the confectionery products 11a to 11h without removing the lid portion 33.

Referring to FIG. 5, the display sheet 1 with attached confectionery products 11a to 11h is alternatively placed inside a one-part box 41 consisting of a base portion 43 and a lid portion 45, connected by means of a hinge 47.

The box 41 is cut from a single piece of cardboard and is folded to create the hinge 47, and to provide each of the base and lid portions 43 and 45 having a rectangular planar sheet 43a and 45a and sidewalls 43b and 45b. The sidewalls 43b extend continuously around the perimeter of the planar sheet 43a of the base portion. In the lid portion 45, the sidewalls 45b extend around three edges of the rectangular planar sheet 45a; the remaining edge of the planar sheet 45a is connected to one of the sidewalls 43b of the base portion 43 by means of hinge 47. The size of the lid portion 45 is such that the lid portion sidewalls 45b fit snugly around the outside of the base portion sidewalls 43b.

The loaded display sheet is placed on the planar sheet 43a of the base portion, between the base portion sidewalls 43b, and the lid portion 45 is folded over the base portion 43 to enclose the confectionery products 11a to 11h. A transparent portion 49 is the planar sheet 45b of the lid portion permit the consumer to view at least some of the confectionery products 11a to 11h without opening the box 41.

Referring to FIG. 6, the display sheet 1 with attached confectionery products 11a to 11h (not shown) is alternatively enclosed within a wrapping material 51 formed from a laminate of polyethylene terephthalate (PET) and polyethene. The wrapping material 51 is wrapped lengthways around the loaded display sheet 1 and heat-sealed (not shown). The two ends are then sealed and cut to form sealed ends 53. The wrapping material 51 is generally printed with coloured designs and information about the product, but includes a transparent portion 55 to permit the consumer to view at least some of the confectionery products 11a to 11h without opening the package.

It will be appreciated that other materials may be used to manufacture the product display sheet 1 in place of the 260 gsm duplex card. For example, a 3-ply structure of E fluted sheet (260 gsm duplex/100 gsm/100 gsm) may be used.

Alternatively, in the embodiments shown in FIGS. 4 and 5, the planar sheet of the base portion (33a; 43a) may form the product display sheet directly, instead of using a separate insert. In this case, the product locations 7a to 7h and adhesive areas 9a to 9f are printed onto the base portion material, preferably before the sidewalls (33b; 43b) are folded into place.

1.-18. (canceled)

19. A product display sheet comprising a display area having a plurality of adhesive areas, each adhesive area comprising one or more adhesive locations, wherein each adhesive area is further associated with one or more product identifiers, and each product identifier comprises a graphical depiction of a product or product range.

20. A product display sheet as claimed in claim 19, wherein each adhesive area comprises a printed layer and an adhesive layer; wherein each product identifier comprises at least part of the printed layer and the one or more adhesive locations comprise at least part of the adhesive layer.

21. A product display sheet as claimed in claim 20, wherein at least part of the adhesive layer overlies at least part of the printed layer.

22. A product display sheet as claimed in claim 19, further comprising one or more release sheets covering substantially all of the adhesive areas.

23. A product display sheet as claimed in claim 19, in which the surface area of each adhesive area is smaller than the surface area occupied by the products indicated in the corresponding product identifier(s).

24. A product display sheet as claimed in claim 19, wherein the display area is substantially planar.

25. A product display sheet having a substantially planar display area; and a plurality of groups of confectionery products releasably mounted on the display area by means of adhesive, each group of confectionery products comprising one or more confectionery products; wherein the display area between the groups of confectionery products is substantially free from adhesive.

26. A product package comprising a product display sheet, one or more confectionery products releasably mounted on the display sheet by means of adhesive, and a covering material; wherein the one or more products are enclosed between the product display sheet and the covering material.

27. A product package as claimed in claim 26, wherein the covering material comprises a transparent portion which enables viewing of at least one confectionery product within the package.

28. A product package as claimed in claim 26, wherein the covering material completely encloses the product display sheet and products mounted thereon.

29. A product package as claimed in claim 26, wherein the product display sheet comprises a planar display area, and a plurality of products are releasably mounted on the planar display area.

30. A method of making a product display sheet according to claim 19, comprising:
providing a display sheet having a display area;
printing at least first and second regions of the display area with indications of products intended to be attached thereto; and
separately coating at least part of each of the first and second regions with a layer of adhesive.

31. A method as claimed in claim 30, further comprising applying one or more release sheets over the layer of adhesive in the first and second regions of the display area.

32. A method of making a product display sheet according to claim 25, comprising:
providing a display sheet having a display area;
selectively coating at least first and second regions of the display area with a layer of temporary adhesive; and
applying at least one confectionery product to the temporary adhesive in each of the first and second regions so as to cover the temporary adhesive.

33. A method of making a product package according to claim 26, comprising:
coating at least part of a display sheet with a layer of temporary adhesive;
applying one or more products to the layer of temporary adhesive; and
applying a covering material to enclose the products between the display sheet and the covering material.

34. A method as claimed in claim 33, wherein the covering material is a flexible wrapper, and applying a covering material to enclose the products between the display sheet and the covering material comprises surrounding the display sheet and products with the covering material and sealing the edges of the covering material.

35. A method as claimed in claim 33, wherein the covering material is a box, and applying the covering material to enclose the products between the display sheet and the covering material comprises placing the display sheet with products attached thereto inside the box.
